(19) United States
(12) Patent Application Publication
(10) Pub. No.: US 2012/0212842 A1
(43) Pub. Date: Aug. 23, 2012

(54) IMAGING LENS AND IMAGING APPARATUS

(75) Inventors: Masaharu Hosoi, Kanagawa (JP); Motoyuki Otake, Saitama (JP)

(73) Assignee: Sony Corporation, Tokyo (JP)

(21) Appl. No.: 13/362,740

(22) Filed: Jan. 31, 2012

(30) Foreign Application Priority Data
Feb. 17, 2011 (JP) 2011-031662

(51) Int. Cl. G02B 9/12

(52) U.S. Cl. 359/784

(57) ABSTRACT

An imaging lens includes: a first lens group; a diaphragm; a second lens group having positive refractive power; and a third lens group having negative refractive power, which are arranged in order from an object side, wherein the first lens group is configured by at least one positive lens and one negative lens, wherein the second lens group is configured by a negative lens, a positive lens, and a positive lens in order from the object side, and wherein, when focusing is performed, the second lens group is moved in a direction of an optical axis.

### FIELD

The present disclosure relates to an imaging lens and an imaging apparatus, and more particularly, to an imaging lens system that is used in an interchangeable lens device of a so-called interchangeable lens digital camera and an imaging apparatus using the imaging lens system.

### BACKGROUND

Recently, interchangeable lens digital cameras have rapidly become widespread. Particularly, since moving images can be captured in an interchangeable lens camera system, there is a demand for an imaging lens that is suitable not only for capturing a still image but also for capturing moving images. When a moving image is captured, it is necessary to move a lens group that performs focusing at high speed so as to follow rapid movement of a subject.

Although there are several types of bright lens types having a photographing view angle of about 25 to 45 degrees and an F value of 3.5 or less for an interchangeable lens camera system, Gauss-type lenses are widely known (for example, see JP-A-6-337348 and JP-A-2009-58651). In the Gauss-type lens, the whole lens system or a part of the lens groups is moved in the direction of the optical axis when focusing is performed.

In addition, other than the Gauss-type lens, a lens system is proposed in which a first lens group having positive refractive power and a second lens group having negative refractive power are included, and the first lens group is moved in the direction of the optical axis when focusing is performed (for example, see JP-A-2009-210910).

### SUMMARY

In the above-described Gauss-type lens, when focusing is performed, the whole lens system or a former lens group and a latter lens group that have a diaphragm interposed therebetween are independently moved in the direction of the optical axis. In such a case, in order to perform focusing by moving the entire lens system at high speed for photographing a moving image, the weight of the focusing lens group is heavy, whereby the size of an actuator used for moving the lenses is large. Accordingly, there is a problem in that the size of a lens barrel is large. In addition, in order to perform focusing at high speed by independently moving the former group and the latter group, a plurality of actuators are built in a lens barrel, whereby there is a problem in that the size of the lens barrel is large. Meanwhile, in a lens other than the Gauss-type lens, a first lens group having positive refractive power and a second lens group having negative refractive power are included from the object side, and the first lens group is moved in the direction of the optical axis when focusing is performed. In such a case, in order to perform focusing at high speed for photographing moving images, since the weight of the first lens group is heavy, the size of a driving actuator is large, whereby there is a problem in that the size of a lens barrel is large.

Thus, it is desirable to provide an imaging lens that is compact and performs focusing at high speed.

An embodiment of the present disclosure is directed to an imaging lens including: a first lens group; a diaphragm; a second lens group having positive refractive power; and a third lens group having negative refractive power, which are arranged in order from an object side. The first lens group is configured by at least one positive lens and one negative lens, the second lens group is configured by a negative lens, a positive lens, and a positive lens in order from the object side, and, when focusing is performed, the second lens group is moved in a direction of an optical axis. According to the above-described imaging lens, by configuring the second lens group to be light-weighted, an effect of moving the second lens group as a focusing lens group at high speed by using a small-size actuator is acquired.

In the above-described imaging lens, the following Conditional Equations (1) and (2) may be satisfied.

0.1<β2<0.8 (1)

1.1<β3<3.0 (2)

Here, β2 is the lateral magnification of the second lens group, and β3 is the lateral magnification of the third lens group.

In addition, in the above-described imaging lens, the following Conditional Equations (3), (4), and (5) may be satisfied.

Nd21<1.7 (3)

Nd22<1.75 (4)

Nd23<1.75 (5)

Here, Nd21 is a refractive index of the medium of a lens, which is closest to the object side, of the second lens group for the d line (wavelength 587.6 nm), Nd22 is a refractive index of the medium of a lens, which is a lens located second from the object side, of the second lens group for the d line (wavelength 587.6 nm), and Nd23 is a refractive index of the medium of a lens, which is located third from the object side, of the second lens group for the d line (wavelength 587.6 nm).

In addition, in the above-described imaging lens, the following Conditional Equation (6) may be satisfied.

−1.5<f21/f2<−0.3 (6)

Here, f21 is the focal length of a lens of the second lens group which is located closest to the object side, and f2 is the focal length of the second lens group.

In addition, in the above-described imaging lens, the first lens group may include a cemented lens formed by bonding a positive lens and a negative lens in order from the object side. Furthermore, in the above-described imaging lens, the first lens group may be configured by a positive lens, a positive lens, and a negative lens in order from the object side.

In addition, in the above-described imaging lens, the third lens group may be configured by a negative lens and a positive lens in order from the object side.

Another embodiment of the present disclosure is directed to an imaging apparatus including: an imaging lens is configured by a first lens group, a diaphragm, a second lens group having positive refractive power, and a third lens group having negative refractive power, in order from an object side; and an imaging device that converts an optical image formed by the imaging lens into an electrical signal. The first lens group is configured by at least one positive lens and one negative lens, the second lens group is configured by a negative lens, a positive lens, and a positive lens in order from the object side, and, when focusing is performed, the second lens group is moved in a direction of an optical axis. According to the above-described imaging apparatus, by configuring the second lens group to be light-weighted, an effect of moving the second lens group as a focusing lens group at high speed by using a small-size actuator is acquired.

The embodiments of the present disclosure provides a superior advantage in that a compact imaging lens performing focusing at high speed.

### BRIEF DESCRIPTION OF THE DRAWINGS

FIG. 1 is a diagram illustrating the lens configuration of an imaging lens according to a first embodiment.

FIGS. 2A to 2C are diagrams illustrating the aberrations of the imaging lens according to the first embodiment at infinite focusing.

FIGS. 3A to 3C are diagrams illustrating the aberrations of the imaging lens according to the first embodiment at short-distance focusing.

FIG. 4 is a diagram illustrating the lens configuration of an imaging lens according to a second embodiment.

FIGS. 5A to 5C are diagrams illustrating the aberrations of the imaging lens according to the second embodiment at infinite focusing.

FIGS. 6A to 6C are diagrams illustrating the aberrations of the imaging lens according to the second embodiment at short-distance focusing.

FIG. 7 is a diagram illustrating the lens configuration of an imaging lens according to a third embodiment.

FIGS. 8A to 8C are diagrams illustrating the aberrations of the imaging lens according to the third embodiment at infinite focusing.

FIGS. 9A to 9C are diagrams illustrating the aberrations of the imaging lens according to the third embodiment at short-distance focusing.

FIG. 10 is a diagram illustrating the lens configuration of an imaging lens according to a fourth embodiment.

FIGS. 11A to 11C are diagrams illustrating the aberrations of the imaging lens according to the fourth embodiment at infinite focusing.

FIGS. 12A to 12C are diagrams illustrating the aberrations of the imaging lens according to the fourth embodiment at short-distance focusing.

FIG. 13 is a diagram illustrating the lens configuration of an imaging lens according to a fifth embodiment.

FIGS. 14A to 14C are diagrams illustrating the aberrations of the imaging lens according to the fifth embodiment at infinite focusing.

FIGS. 15A to 15C are diagrams illustrating the aberrations of the imaging lens according to the fifth embodiment at short-distance focusing.

FIG. 16 is a diagram illustrating an example in which the imaging lens according to any one of the first to fifth embodiments is applied to an imaging apparatus.

### DETAILED DESCRIPTION

An imaging lens according to an embodiment of the present disclosure is configured by a first lens group GR1, a diaphragm S, a second lens group GR2 having positive refractive power, and a third lens group GR3 having negative refractive power in order from the object side. The first lens group GR1 is configured by at least one positive lens L12 and one negative lens L13. The second lens group GR2 is configured by a negative lens L21, a positive lens L22, and a positive lens L23 in order from the object side. When focusing is performed, the second lens group GR2 is moved in the direction of an optical axis.

Since the second lens group GR2 is arranged immediately after the diaphragm S and has a small external form, it has a light weight and can be moved at high speed by a small-size actuator. Accordingly, by using the second lens group GR2 as a focusing lens group, the focusing lens group can be moved at high speed while the size of the lens barrel is maintained to be compact.

In addition, by employing the power arrangement in which the second lens group GR2 has positive refractive power, and the third lens group GR3 has negative refractive power, when the second lens group GR2 is moved in the direction of the optical axis, the ratio (focus sensitivity) of the variation amount of the position of the image surface to the amount of the movement of the second lens group GR2 is high. Since the focus stroke can be shortened by configuring the focus sensitivity to be high, the length of the whole lens can be shortened.

It is preferable that the imaging lens according to the embodiment of the present disclosure satisfies the following Conditional Equation (1).

0.1<β2<0.8 (1)

Here, β2 is the lateral magnification of the second lens group GR2. The lateral magnification is a magnification on an image surface.

Conditional Equation (1) defines the lateral magnification of the second lens group GR2. In a case where the lateral magnification is below the range represented in Conditional Equation (1), since the power of the second lens group GR2 is too strong, the eccentricity sensitivity is high, whereby the degree of the manufacturing difficulty increases. On the other hand, in a case where the lateral magnification is above the range represented in Conditional Equation (1), the focus sensitivity is low so as to lengthen the focus stroke, whereby the length of the whole lens is lengthened.

In addition, in the imaging lens according to the embodiment of the present disclosure, it is preferable that the range of numerical values that is represented in Conditional Equation (1) is set to a range represented in the following Conditional Equation (1′).

0.15<β2<0.7 (1′)

Furthermore, in the imaging lens according to the embodiment of the present disclosure, it is more preferable that the range of numerical values represented in Conditional Equation (1) is set to a range represented in the following Conditional Equation (1″). By setting the lateral magnification to be in the range of numerical values represented in Conditional Equation (1″), the length of the whole lens can be further decreased while the eccentricity sensitivity is suppressed.

0.15<β2<0.6 (1″)

In addition, it is preferable that the imaging lens according to the embodiment of the present disclosure satisfies the following Conditional Equation (2).

1.1<β3<3.0 (2)

Here, β3 is the lateral magnification of the third lens group GR3.

Conditional Equation (2) defines the lateral magnification of the third lens group GR3. In a case where the lateral magnification is below the range represented in Conditional Equation (2), since the focus sensitivity is low so as to lengthen the focus stroke, whereby the length of the whole lens is lengthened. On the other hand, in a case where the lateral magnification is above the range represented in Conditional Equation (2), since the power of the third lens group GR3 is too strong, the eccentricity sensitivity is increased, whereby the degree of the manufacturing difficulty rises.

In addition, in the imaging lens according to the embodiment of the present disclosure, it is preferable that the range of numerical values that is represented in Conditional Equation (2) is set to a range represented in the following Conditional Equation (2′).

1.1<β3<2.0 (2′)

Furthermore, in the imaging lens according to the embodiment of the present disclosure, it is more preferable that the range of numerical values represented in Conditional Equation (2) is set to a range represented in the following Conditional Equation (2″). By setting the lateral magnification to be in the range of numerical values represented in Conditional Equation (2″), the length of the whole lens can be further decreased while the eccentricity sensitivity is suppressed.

1.2<β3<1.8 (2″)

In addition, it is preferable that the imaging lens according to the embodiment of the present disclosure satisfies the following Conditional Equations (3), (4), and (5).

Nd21<1.7 (3)

Nd22<1.75 (4)

Nd23<1.75 (5)

Here, Nd21 is a refractive index of the medium of the lens L21 for the d line (wavelength 587.6 nm), Nd22 is a refractive index of the medium of the lens L22 for the d line (wavelength 587.6 nm), and Nd23 is a refractive index of the medium of the lens L23 for the d line (wavelength 587.6 nm).

Conditional Equation (3) defines the refractive index of the negative lens L21 of the second lens group GR2 for the d line. In addition, Conditional Equations (4) and (5) define the refractive indexes of the positive lenses L22 and L23 of the second lens group GR2 for the d line. In a case where the refractive index is above the ranges represented in Conditional Equations (3), (4), and (5), since the specific gravity of the medium increases so as to increase the weight of the lens, the size of an actuator used for moving the focusing group is increased, whereby the size of the lens barrel is increased.

In addition, in the imaging lens according to the embodiment of the present disclosure, it is preferable that the range of numerical values that is represented in Conditional Equation (3) is set to a range represented in the following Conditional Equation (3′). By setting the range to the range of numerical values described below, the weight of the second lens group GR2 can be decreased further.

Nd21<1.6 (3′)

It is preferable that the imaging lens according to the embodiment of the present disclosure satisfies the following Conditional Equation (6).

−1.5<f21/f2<−0.3 (6)

Here, f21 is the focal length of the lens L21, and f2 is the focal length of the second lens group.

Conditional Equation (6) defines the focal length of the lens L21 of the second lens group GR2 that is arranged to be closest to the object side with respect to the focal length of the second lens group GR2. In a case where the ratio is below the range represented in Conditional Equation (6), since the power of the lens L21 is too low, the effect of aberration correction is decreased, whereby the axial chromatic aberration and the chromatic aberration of magnification are degraded. On the other hand, in a case where the ratio is above the range represented in Conditional Equation (6), since the power of the lens L21 is too strong, the sensitivity for the relative eccentricity inside the second lens group GR2 increases, whereby the degree of manufacturing difficulty is increased.

In addition, in the imaging lens according to the embodiment of the present disclosure, it is preferable that the range of numerical values that is represented in Conditional Equation (6) is set to a range represented in the following Conditional Equation (6′).

−1.2<f21/f2<−0.4 (6′)

Furthermore, in the imaging lens according to the embodiment of the present disclosure, it is more preferable that the range of numerical values represented in Conditional Equation (6) is set to a range represented in the following Conditional Equation (6″). By setting the ratio to be in the range of numerical values represented in Conditional Equation (6″), the chromatic aberration can be further corrected while the eccentricity sensitivity is suppressed.

−1.0<f21/f2<−0.5 (6″)

In the imaging lens according to the embodiment of the present disclosure, it is preferable that the first lens group GR1 is configured by a cemented lens acquired by affixing a positive lens L12 and a negative lens L13 from the object side. By employing such a configuration, the first lens group GR1 can be formed to be thin while the axial chromatic aberration and the chromatic aberration of magnification are corrected well. Accordingly, an excellent performance can be acquired while the size of the lens barrel is maintained to be compact.

In addition, it is preferable that the first lens group GR1 is configured by a positive lens L11, a positive lens L12, and a negative lens L13 in order from the object side. By employing such a configuration, off-axis aberrations, more particularly, the comma aberration and the chromatic aberration of magnification can be corrected well.

In the imaging lens according to the embodiment of the present disclosure, it is preferable that the third lens group GR3 having negative refractive power is configured by a negative lens L31 and a positive lens L32 in order from the object side. By employing such a configuration, off-axis aberrations, and more particularly, the distortion aberration, the astigmatism, and the curvature of the image surface can be corrected well.

Hereinafter, exemplary embodiments (hereinafter, referred to as embodiments) according to the present disclosure will be described. The description will be presented in the following order.

1. First Embodiment (Numerical value Example 1)

2. Second Embodiment (Numerical value Example 2)

3. Third Embodiment (Numerical value Example 3)

4. Fourth Embodiment (Numerical value Example 4)

5. Fifth Embodiment (Numerical value Example 5)

6. Application Example (Imaging Apparatus)

The meanings and the like of symbols shown in tables and description presented below are as follows. A “surface number” represents an i-th surface counted from the object side, “Ri” represents the radius of curvature of the i-th surface, and “Di” represents an axial upper surface gap (the thickness of the center of the lens or an air gap) between the i-th surface counted from the object side and the (i+1)-th surface. In addition, “Ni” represents the refractive index of the material configuring the i-th lens for the d line (wavelength 587.6 mm), “νi” represents an Abbe number of the material configuring the i-th lens for the d line (wavelength 587.6 nm), “f” represents the focal length of the whole lens system, “Fno” represents the full aperture F number, and “co” represents a half angle of view. Furthermore, “∞” represents that the corresponding surface is a planar surface, and “ASP” represents that the corresponding surface is aspheric. In addition, the axial upper surface gap “Di” that is a variable gap is denoted as “variable”.

In some of imaging lenses used in the embodiments, the lens surface is configured by an aspheric surface. When a distance from the apex of the lens surface in the optical axis direction is “x”, a height in a direction perpendicular to the optical axis is “y”, paraxial curvature at the lens apex is “c”, and a conic constant is “κ”, the distance x is defined such that x=cy²/(1+(1−(1+κ)c²y²)^{1/2})+A2y²+A4y⁴+A6y⁶+A8y⁸+A10y¹⁰. Here, A2, A4, A6, A8, and A10 are the second-order, fourth-order, sixth-order, eighth-order, and tenth-order aspheric coefficients.

### 1. First Embodiment

### [Configuration of Lens]

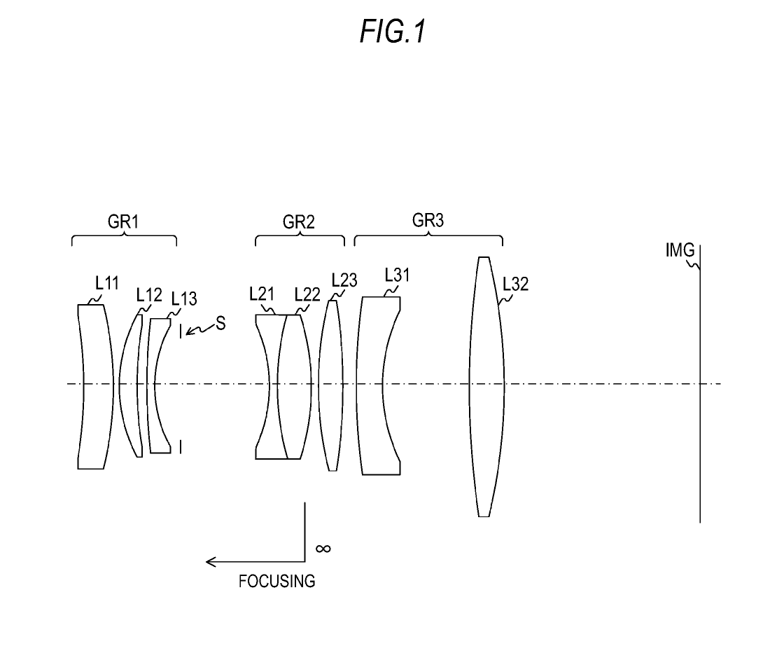

FIG. 1 is a diagram illustrating the lens configuration of an imaging lens according to a first embodiment of the present disclosure. A first lens group GR1 is configured by a positive meniscus lens L11 having a concave surface facing the object side, a positive meniscus lens L12 having a convex surface facing the object side, and a negative meniscus lens L13 having a concave surface facing the object side in order from the object side.

A second lens group GR2 is configured by a cemented lens acquired by bonding a biconcave lens L21 and a biconvex lens L22 and a biconvex lens L23 having aspheric surfaces formed on both faces.

A third lens group GR3 is configured by a negative meniscus lens L31 that has an aspheric surface on the image-side face and has a convex surface facing the object side and a biconvex lens L32. By moving the whole third lens group GR3 or the negative lens L31 of the third lens group GR3 in a direction perpendicular to the optical axis, an image can be shifted.

In addition, a diaphragm S is arranged between the first lens group GR1 and the second lens group GR2 and a filter (not illustrated in the figure) is arranged between the third lens group GR3 and an image surface IMG.

### [Specification of Imaging Lens]

Table 1 illustrates the lens data of Numerical value Example 1 in which specific numerical values are applied to the imaging lens according to the first embodiment.

TABLE 1

| Surface No. | R | D | Nd | νd |
|---|---|---|---|---|
| 1 | −60.813 | 3.000 | 1.83481 | 42.72 |
| 2 | −37.737 | 0.600 | | |
| 3 | 15.859 | 1.964 | 1.883 | 40.8048 |
| 4 | 48.769 | 1.000 | | |
| 5 | 170.562 | 0.700 | 1.62004 | 36.3 |
| 6 | 12.114 | 2.580 | | |
| 7 | infinite | D7 | | |
| 8 | −15.000 | 0.800 | 1.58144 | 40.89 |
| 9 | 26.413 | 3.500 | 1.6968 | 55.4589 |
| 10 | −21.926 | 0.600 | | |
| 11 (ASP) | 31.168 | 2.500 | 1.6935 | 53.2 |
| 12 (ASP) | −58.500 | D12 | | |
| 13 | 120.188 | 2.500 | 1.69895 | 30.05 |
| 14 (ASP) | 18.151 | 8.911 | | |
| 15 | 84.783 | 3.500 | 1.883 | 40.8048 |
| 16 | −53.590 | 20.231 | | |

In the imaging lens according to the first embodiment, the eleventh surface, the twelfth surface, and the fourteenth surface are configured in aspheric shapes as described above. Conic constants κ of each surface, and the fourth-order, sixth-order, and eighth-order, and tenth-order aspheric coefficients A11, A12, and A14 are represented in Table 2.

TABLE 2

| Surface No. | κ | A4 | A6 | A8 | A10 |
|---|---|---|---|---|---|
| 11 | 0.00000 | −4.96424E−07 | −2.17785E−07 | 7.60814E−09 | −7.48032E−11 |
| 12 | 0.00000 | 3.33386E−06 | −2.66074E−07 | 8.71827E−09 | −7.92793E−11 |
| 14 | 0.00000 | 8.46006E−06 | −1.29807E−07 | 9.95149E−10 | −6.60302E−12 |

In the first embodiment, when the lens position changes from the wide angle end to the telephoto end, the following gaps between lens groups change. The gaps between the lens groups include a gap D7 between the first lens group GR1 and the diaphragm, and a gap D12 between the second lens group GR2 and the third lens group GR3. The numerical values of the gaps D7 and D12, the focal lengths f, the maximum apertures Fno, the half angles ω, and the lateral magnifications β at infinite focusing and short-distance focusing are represented in Table 3.

TABLE 3

| | Infinite Focusing | Short-Distance Focusing |
|---|---|---|
| Fno | 2.86 | — |
| f | 36.05 | — |
| ω | 20.96 | — |
| β | 0.000 | −0.025 |
| D7 | 9.030 | 8.442 |
| D12 | 1.496 | 2.084 |

### [Aberration of Imaging Lens]

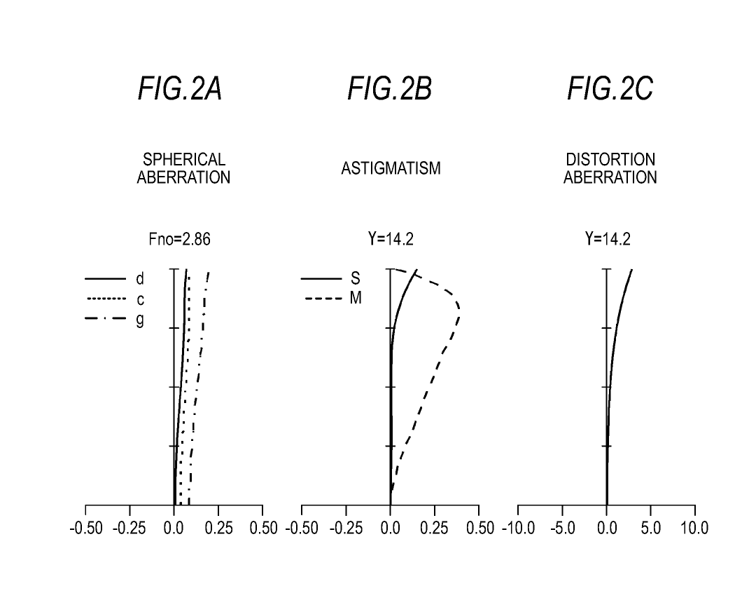

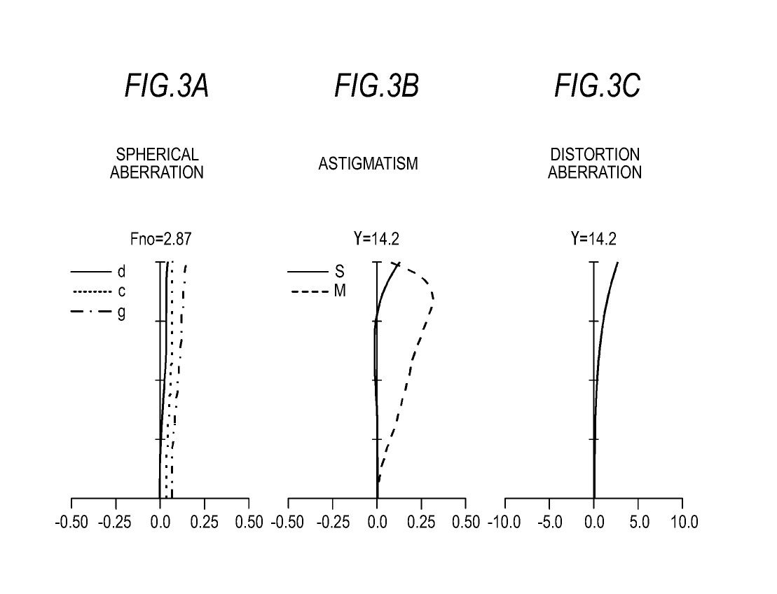

FIGS. 2A to 3C are diagrams illustrating the aberrations of the imaging lens according to the first embodiment. FIGS. 2A to 2C are diagrams illustrating the aberrations of the imaging lens according to the first embodiment at infinite focusing. FIGS. 3A to 3C are diagrams illustrating the aberrations of the imaging lens according to the first embodiment at short-distance focusing. The diagrams denoted by being posted by A, B, and C are diagrams illustrating a spherical aberration, astigmatism, and a distortion aberration.

In addition, in the diagram illustrating the spherical aberration, a solid line, a dotted line, and a short-dashed line represent the values at the d line (587.6 nm), line c (wavelength 656.3 nm), and line g (wavelength 435.8 nm). In addition, in the diagram illustrating the astigmatism, a solid line S represents the value on a sagittal image surface, and a dotted line M represents the value on a meridional image surface.

### 2. Second Embodiment

### [Configuration of Lens]

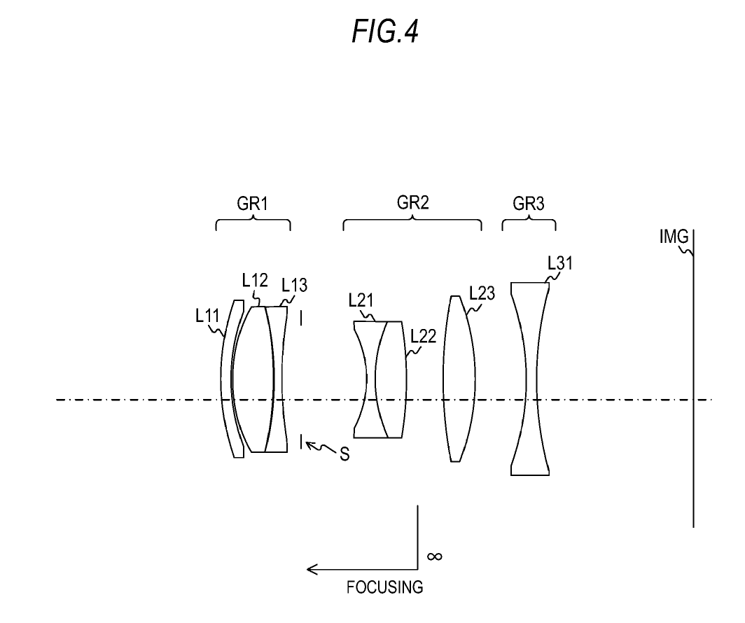

FIG. 4 is a diagram illustrating the lens configuration of an imaging lens according to a second embodiment. A first lens group GR1 is configured by a positive meniscus lens L11 having a convex surface facing the object side and a cemented lens in which a biconvex lens L12 and a biconcave lens L13 are bonded together, in order from the object side.

A second lens group GR2 is configured by a cemented lens in which a biconcave lens L21 and a biconvex les L22 are bonded together and a biconvex lens L23 having aspheric surfaces on both faces, in order from the object side.

A third lens group GR3 is configured by a biconcave lens L31 having an aspheric surface formed on an image-side face. By moving the third lens group GR3 in a direction perpendicular to the optical axis, the image can be shifted.

In addition, a diaphragm S is arranged between the first lens group GR1 and the second lens group GR2 and a filter (not illustrated in the figure) is arranged between the third lens group GR3 and an image surface IMG.

### [Specification of Imaging Lens]

Table 4 illustrates the lens data of Numerical value Example 2 in which specific numerical values are applied to the imaging lens according to the second embodiment.

TABLE 4

| Surface No. | R | D | Nd | νd |
|---|---|---|---|---|
| 1 | 24.353 | 1.000 | 1.835 | 42.9836 |
| 2 | 18.311 | 0.100 | | |
| 3 | 14.042 | 3.967 | 1.618 | 63.3949 |
| 4 | −30.020 | 0.700 | 1.56732 | 42.8164 |
| 5 | 35.226 | 1.932 | | |
| 6 | infinite | D6 | | |
| 7 | −11.800 | 0.800 | 1.54072 | 47.2264 |
| 8 | 12.919 | 3.000 | 1.6968 | 55.4589 |
| 9 | −36.540 | 3.497 | | |
| 10 (ASP) | 32.388 | 3.100 | 1.58913 | 61.2517 |
| 11 (ASP) | −17.277 | D11 | | |
| 12 | −23.739 | 1.000 | 1.51742 | 52.4301 |
| 13 (ASP) | 30.184 | 15.000 | | |

In the imaging lens according to the second embodiment, the tenth surface, the eleventh surface, and the thirteenth surface are configured in aspheric shapes as described above. Conic constants κ and the fourth-order, sixth-order, and eighth-order, and tenth-order aspheric coefficients A11, A12, and A14 of each surface are represented in Table 5.

TABLE 5

| Surface No. | κ | A4 | A6 | A8 | A10 |
|---|---|---|---|---|---|
| 10 | 0.00000 | −1.70253E−05 | −6.72182E−07 | 2.70525E−08 | −4.17159E−10 |
| 11 | 0.00000 | 1.10666E−04 | −1.51704E−06 | 4.70307E−08 | −5.60590E−10 |
| 13 | 0.00000 | −2.68580E−05 | −2.17266E−08 | 2.37596E−09 | −1.44058E−11 |

In the second embodiment, when the lens position changes from the wide angle end to the telephoto end, the following gaps between lens groups change. The gaps between the lens groups include a gap D6 between the first lens group GR1 and the diaphragm and a gap D11 between the second lens group GR2 and the third lens group GR3. The numerical values of the gaps D6 and D11, the focal lengths f, the maximum apertures Fno, the half angles ω, and the lateral magnifications β at infinite focusing and short-distance focusing are represented in Table 6.

TABLE 6

| | Infinite Focusing | Short-Distance Focusing |
|---|---|---|
| Fno | 2.88 | — |
| f | 35.44 | — |
| ω | 20.88 | — |
| β | 0.000 | −0.025 |
| D6 | 6.065 | 5.630 |
| D11 | 4.796 | 5.231 |

### [Aberration of Imaging Lens]

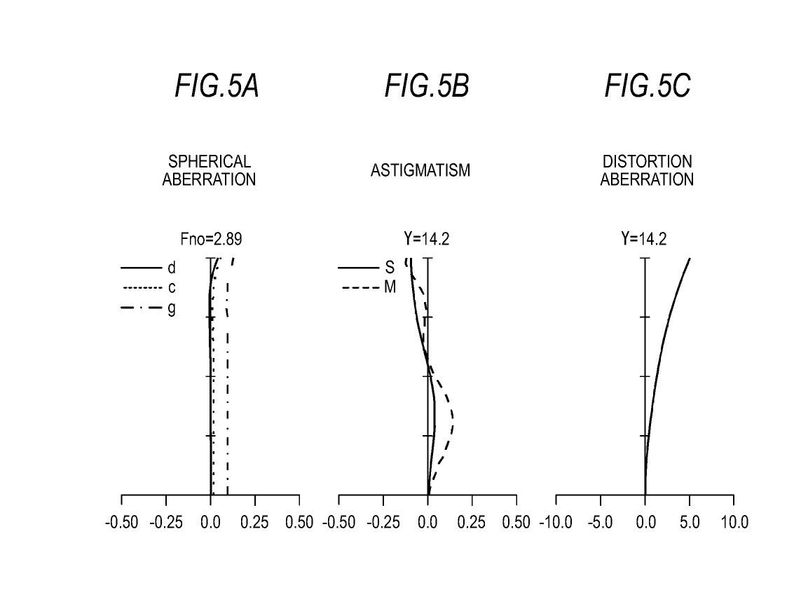

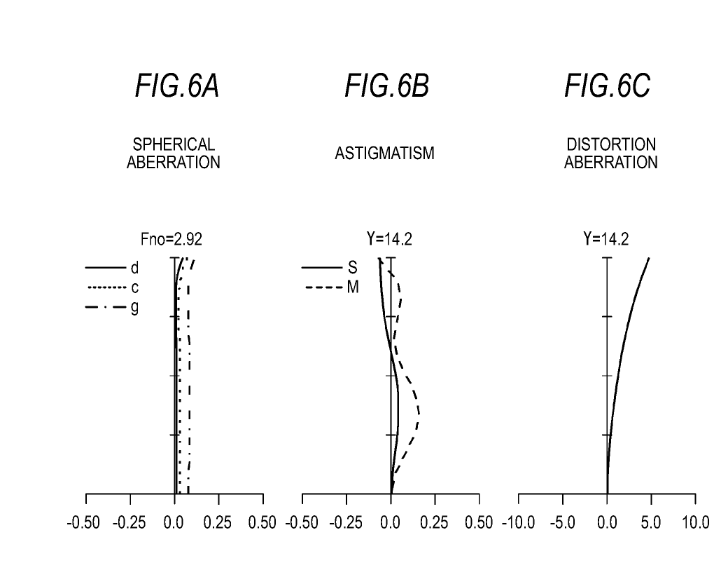

FIGS. 5A to 6C are diagrams illustrating the aberrations of the imaging lens according to the second embodiment. FIGS. 5A to 5C are diagrams illustrating the aberrations of the imaging lens according to the second embodiment at infinite focusing. FIGS. 6A to 6C are diagrams illustrating the aberrations of the imaging lens according to the second embodiment at short-distance focusing. The diagrams denoted by being posted by A, B, and C are diagrams illustrating a spherical aberration, astigmatism, and a distortion aberration. In addition, the types of lines shown in the diagrams illustrating the aberrations are similar to those described in the first embodiment.

### 3. Third Embodiment

### [Configuration of Lens]

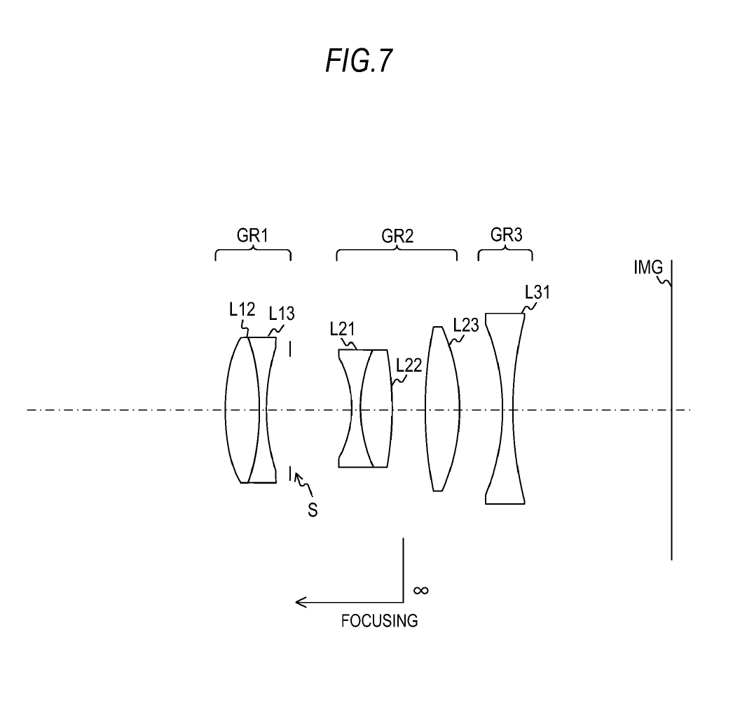

FIG. 7 is a diagram illustrating the lens configuration of an imaging lens according to a third embodiment. A first lens group GR1 is configured by a cemented lens in which a biconvex lens L12 and a biconcave lens L13 are bonded together in order from the object side.

A second lens group GR2 is configured by a cemented lens in which a biconcave lens L21 and a biconvex les L22 are bonded together and a biconvex lens L23 having aspheric surfaces on both faces, in order from the object side.

A third lens group GR3 is configured by a biconcave lens L31 having an aspheric surface formed on an image-side face. By moving the third lens group GR3 in a direction perpendicular to the optical axis, the image can be shifted.

In addition, a diaphragm S is arranged between the first lens group GR1 and the second lens group GR2 and a filter (not illustrated in the figure) is arranged between the third lens group GR3 and an image surface IMG.

### [Specification of Imaging Lens]

Table 7 illustrates the lens data of Numerical value Example 3 in which specific numerical values are applied to the imaging lens according to the third embodiment.

TABLE 7

| Surface No. | R | D | Nd | νd |
|---|---|---|---|---|
| 1 | 14.782 | 3.321 | 1.618 | 63.3949 |
| 2 | −21.244 | 0.700 | 1.56732 | 42.8164 |
| 3 | 23.345 | 2.157 | | |
| 4 | infinite | D4 | | |
| 5 | −11.800 | 0.800 | 1.54072 | 47.2264 |
| 6 | 15.768 | 3.000 | 1.6968 | 55.4589 |
| 7 | −34.427 | 3.066 | | |
| 8 (ASP) | 34.374 | 3.100 | 1.58913 | 61.2517 |
| 9 (ASP) | −16.084 | D9 | | |
| 10 | −21.742 | 1.000 | 1.51742 | 52.4301 |
| 11 (ASP) | 31.954 | 15.000 | | |

In the imaging lens according to the third embodiment, the eighth surface, the ninth surface, and the eleventh surface are configured in aspheric shapes as described above. Conic constants κ and the fourth-order, sixth-order, and eighth-order, and tenth-order aspheric coefficients A11, A12, and A14 of each surface are represented in Table 8.

TABLE 8

| Surface No. | κ | A4 | A6 | A8 | A10 |
|---|---|---|---|---|---|
| 8 | 0.00000 | −2.61965E−05 | −3.92289E−07 | 2.55508E−08 | −4.27043E−10 |
| 9 | 0.00000 | 1.04178E−04 | −1.42254E−06 | 5.10545E−08 | −6.26924E−10 |
| 11 | 0.00000 | −3.05215E−05 | 6.76709E−08 | 5.81535E−10 | −1.30870E−12 |

In the third embodiment, when the lens position changes from the wide angle end to the telephoto end, the following gaps between lens groups change. The gaps between the lens groups include a gap D4 between the first lens group GR1 and the diaphragm and a gap D9 between the second lens group GR2 and the third lens group GR3. The numerical values of the gaps D4 and D9, the focal lengths f, the maximum apertures Fno, the half angles ω, and the lateral magnifications β at infinite focusing and short-distance focusing are represented in Table 9.

TABLE 9

| | Infinite Focusing | Short-Distance Focusing |
|---|---|---|
| Fno | 2.83 | — |
| f | 34.48 | — |
| ω | 21.40 | — |
| β | 0.000 | −0.025 |
| D4 | 5.837 | 5.411 |
| D9 | 4.056 | 4.482 |

### [Aberration of Imaging Lens]

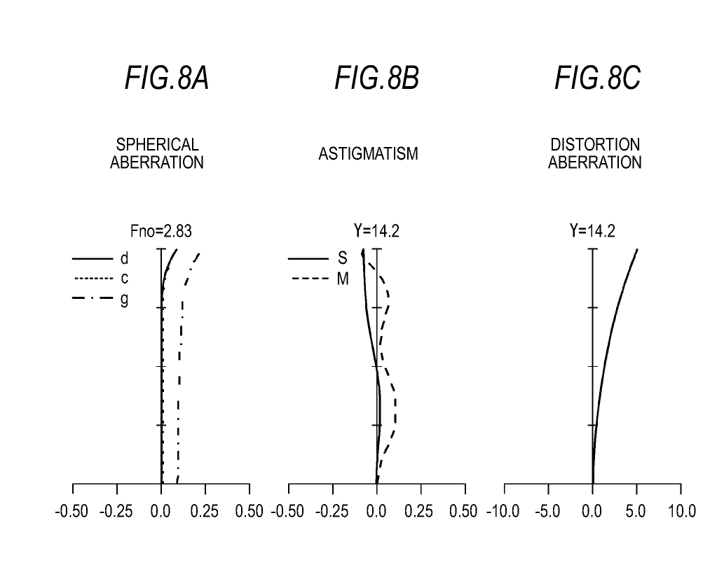

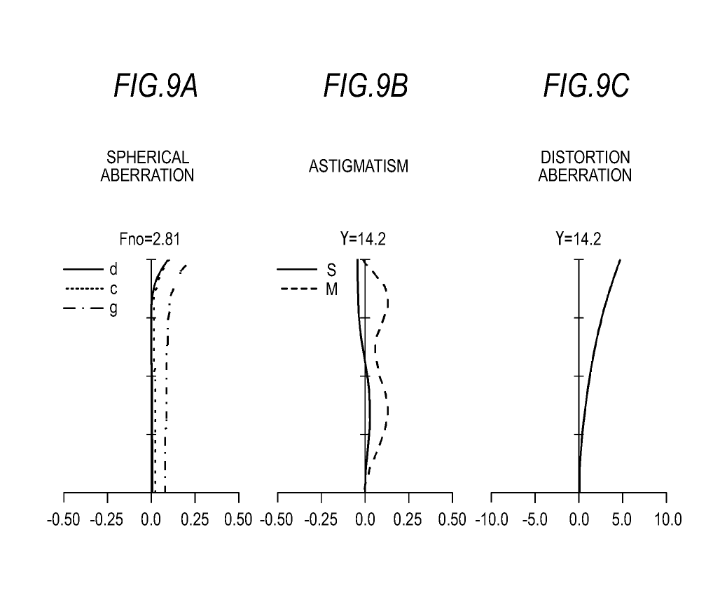

FIGS. 8A to 9C are diagrams illustrating the aberrations of the imaging lens according to the third embodiment. FIGS. 8A to 8C are diagrams illustrating the aberrations of the imaging lens according to the third embodiment at infinite focusing. FIGS. 9A to 9C are diagrams illustrating the aberrations of the imaging lens according to the third embodiment at short-distance focusing. The diagrams denoted by being posted by A, B, and C are diagrams illustrating a spherical aberration, astigmatism, and a distortion aberration. In addition, the types of lines shown in the diagrams illustrating the aberrations are similar to those described in the first embodiment.

### 4. Fourth Embodiment

### [Configuration of Lens]

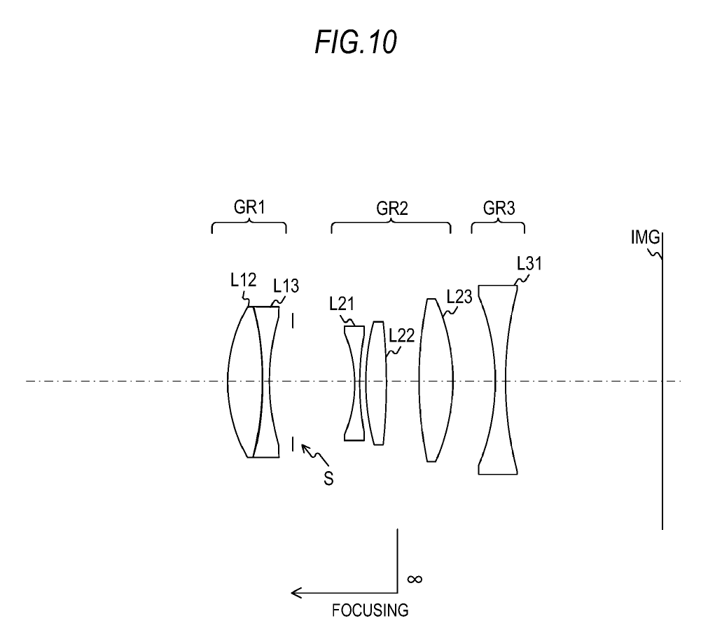

FIG. 10 is a diagram illustrating the lens configuration of an imaging lens according to a fourth embodiment. A first lens group GR1 is configured by a cemented lens in which a biconvex lens L12 and a biconcave lens L13 are bonded together in order from the object side.

A second lens group GR2 is configured by a biconcave lens L21, a biconvex lens L22, and a biconvex lens L23 having aspheric surfaces on both faces in order from the object side.

A third lens group GR3 is configured by a biconcave lens L31 having an aspheric surface formed on an image-side face. By moving the third lens group in a direction perpendicular to the optical axis, the image can be shifted.

In addition, a diaphragm S is arranged between the first lens group GR1 and the second lens group GR2 and a filter (not illustrated in the figure) is arranged between the third lens group GR3 and an image surface IMG.

### [Specification of Imaging Lens]

Table 10 illustrates the lens data of Numerical value Example 4 in which specific numerical values are applied to the imaging lens according to the fourth embodiment.

TABLE 10

| Surface No. | R | D | Nd | νd |
|---|---|---|---|---|
| 1 | 14.077 | 3.293 | 1.618 | 63.3949 |
| 2 | −23.555 | 0.700 | 1.56732 | 42.8164 |
| 3 | 21.972 | 2.200 | | |
| 4 | infinite | D4 | | |
| 5 | −12.901 | 0.500 | 1.54072 | 47.2264 |
| 6 | 24.924 | 0.500 | | |
| 7 | 17.340 | 2.018 | 1.6968 | 55.4589 |
| 8 | −107.638 | 3.288 | | |
| 9 (ASP) | 32.734 | 3.100 | 1.58913 | 61.2517 |
| 10 (ASP) | −15.972 | D10 | | |
| 11 | −19.585 | 1.000 | 1.51742 | 52.4301 |
| 12 (ASP) | 33.800 | 15.000 | | |

In the imaging lens according to the fourth embodiment, the ninth surface, the tenth surface, and the twelfth surface are configured in aspheric shapes as described above. Conic constants κ and the fourth-order, sixth-order, and eighth-order, and tenth-order aspheric coefficients A11, A12, and A14 of each surface are represented in Table 11.

TABLE 11

| Surface No. | κ | A4 | A6 | A8 | A10 |
|---|---|---|---|---|---|
| 9 | 0.00000 | −5.99443E−05 | −1.16022E−06 | 3.64840E−08 | −3.79074E−10 |
| 10 | 0.00000 | 1.13174E−04 | −1.80573E−06 | 5.07920E−08 | −4.04263E−10 |
| 12 | 0.00000 | −4.25906E−05 | 3.84978E−07 | −6.36496E−09 | 4.63456E−11 |

In the fourth embodiment, when the lens position changes from the wide angle end to the telephoto end, the following gaps between lens groups change. The gaps between the lens groups include a gap D4 between the first lens group GR1 and the diaphragm and a gap D10 between the second lens group GR2 and the third lens group GR3. The numerical values of the gaps D4 and D10, the focal lengths f, the maximum apertures Fno, the half angles ω, and the lateral magnifications β at infinite focusing and short-distance focusing are represented in Table 12.

TABLE 12

| | Infinite Focusing | Short-Distance Focusing |
|---|---|---|
| Fno | 2.86 | — |
| f | 35.27 | — |
| ω | 21.00 | — |
| β | 0.000 | −0.025 |
| D4 | 5.801 | 5.375 |
| D10 | 3.843 | 4.269 |

### [Aberration of Imaging Lens]

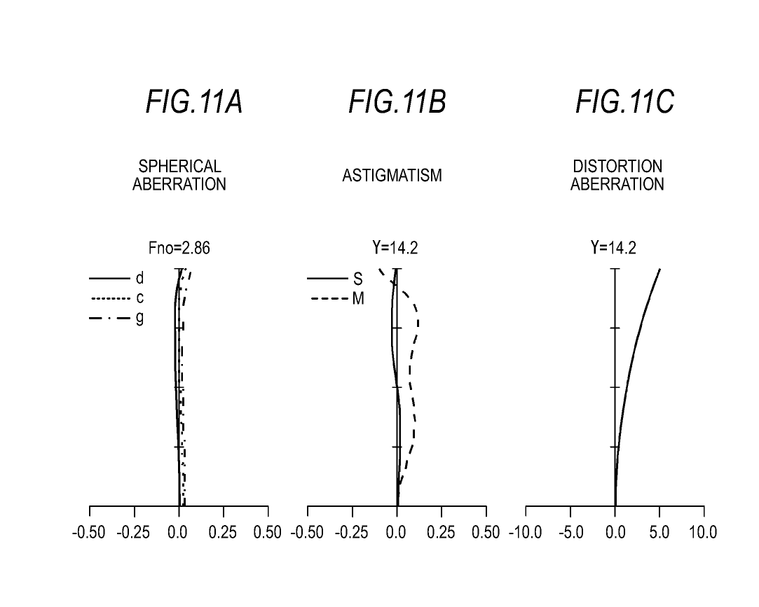

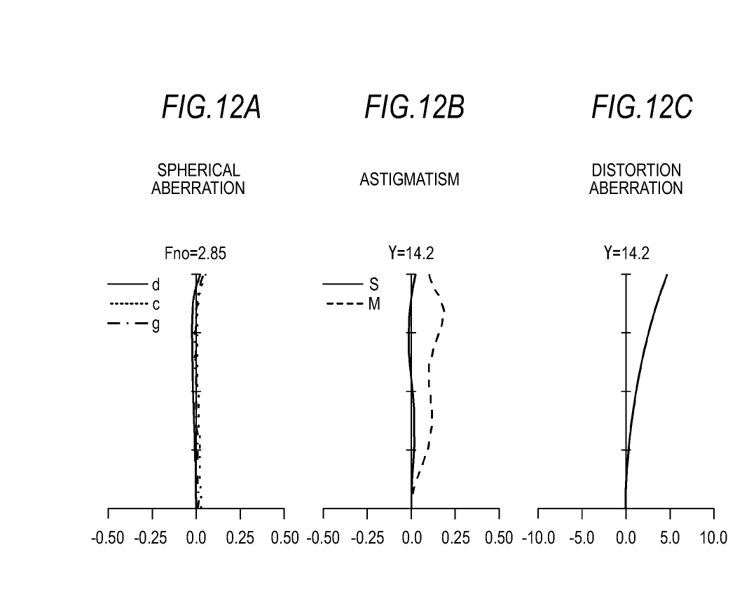

FIGS. 11A to 12C are diagrams illustrating the aberrations of the imaging lens according to the fourth embodiment. FIGS. 11A to 11C are diagrams illustrating the aberrations of the imaging lens according to the fourth embodiment at infinite focusing. FIGS. 12A to 12C are diagrams illustrating the aberrations of the imaging lens according to the fourth embodiment at short-distance focusing. The diagrams denoted by being posted by A, B, and C are diagrams illustrating a spherical aberration, astigmatism, and a distortion aberration. In addition, the types of lines shown in the diagrams illustrating the aberrations are similar to those described in the first embodiment.

### 5. Fifth Embodiment

### [Configuration of Lens]

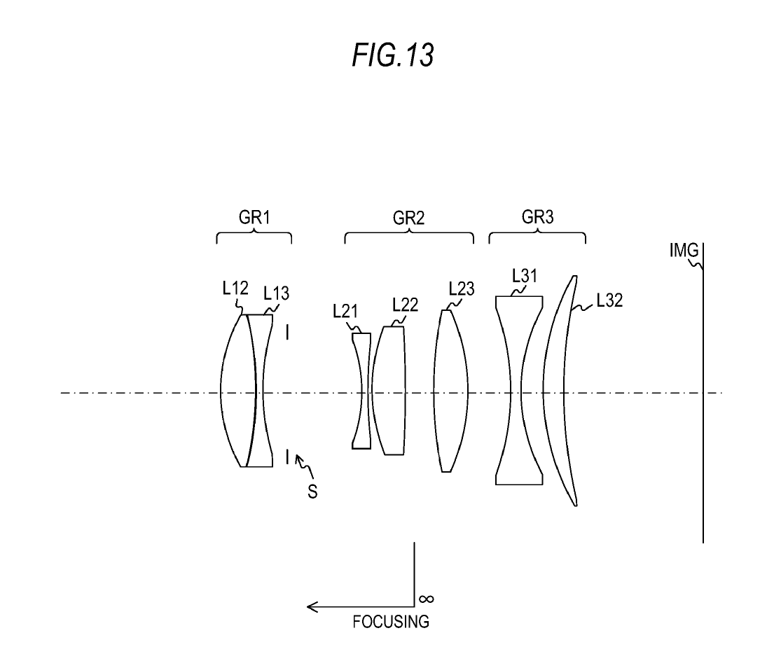

FIG. 13 is a diagram illustrating the lens configuration of an imaging lens according to a fifth embodiment. A first lens group GR1 is configured by a cemented lens in which a biconvex lens L12 and a biconcave lens L13 are bonded together in order from the object side.

A second lens group GR2 is configured by a biconcave lens L21, a biconvex lens L22, and a biconvex lens L23 having aspheric surfaces on both faces in order from the object side.

A third lens group GR3 is configured by a biconcave lens L31 having an aspheric surface formed on an image-side face and a positive meniscus lens L32 having a convex surface facing an object-side surface. By moving the whole third lens group GR3 or the negative lens L31 of the third lens group GR3 in a direction perpendicular to the optical axis, the image can be shifted.

In addition, a diaphragm S is arranged between the first lens group GR1 and the second lens group GR2 and a filter (not illustrated in the figure) is arranged between the third lens group GR3 and an image surface IMG.

### [Specification of Imaging Lens]

Table 13 illustrates the lens data of Numerical value Example 5 in which specific numerical values are applied to the imaging lens according to the fifth embodiment.

TABLE 13

| Surface No. | R | D | Nd | νd |
|---|---|---|---|---|
| 1 | 15.069 | 3.384 | 1.618 | 63.3949 |
| 2 | −24.799 | 0.700 | 1.56732 | 42.8164 |
| 3 | 21.952 | 2.200 | | |
| 4 | infinite | D4 | | |
| 5 | −13.701 | 0.500 | 1.54072 | 47.2264 |
| 6 | 52.558 | 0.500 | | |
| 7 | 18.856 | 3.000 | 1.6968 | 55.4589 |
| 8 | −522.021 | 2.713 | | |
| 9 (ASP) | 34.523 | 3.100 | 1.58913 | 61.2517 |
| 10 (ASP) | −17.240 | D10 | | |
| 11 | −23.264 | 1.000 | 1.51742 | 52.43 |
| 12 (ASP) | 15.840 | 2.014 | | |
| 13 | 21.037 | 2.000 | 1.5168 | 64.1973 |
| 14 | 43.711 | 13.000 | | |

In the imaging lens according to the fifth embodiment, the ninth surface, the tenth surface, and the twelfth surface are configured in aspheric shapes as described above. Conic constants κ and the fourth-order, sixth-order, and eighth-order, and tenth-order aspheric coefficients A11, A12, and A14 of each surface are represented in Table 14.

TABLE 14

| Surface No. | κ | A4 | A6 | A8 | A10 |
|---|---|---|---|---|---|
| 9 | 0.00000 | −7.38621E−05 | −9.56211E−07 | 2.75399E−08 | −1.82972E−10 |
| 10 | 0.00000 | 8.10703E−05 | −1.21591E−06 | 3.14556E−08 | −1.55358E−10 |
| 12 | 0.00000 | −3.44356E−05 | −7.19498E−08 | −1.24027E−09 | 1.24990E−11 |

In the fifth embodiment, when the lens position changes from the wide angle end to the telephoto end, the following gaps between lens groups change. The gaps between the lens groups include a gap D4 between the first lens group GR1 and the diaphragm and a gap D10 between the second lens group GR2 and the third lens group GR3. The numerical values of the gaps D4 and D10, the focal lengths f, the maximum apertures Fno, the half angles ω, and the lateral magnifications β at infinite focusing and short-distance focusing are represented in Table 15.

TABLE 15

| | Infinite Focusing | Short-Distance Focusing |
|---|---|---|
| Fno | 3.11 | — |
| f | 37.98 | — |
| ω | 19.61 | — |
| β | 0.000 | −0.025 |
| D4 | 6.966 | 6.558 |
| D10 | 3.998 | 4.406 |

### [Aberration of Imaging Lens]

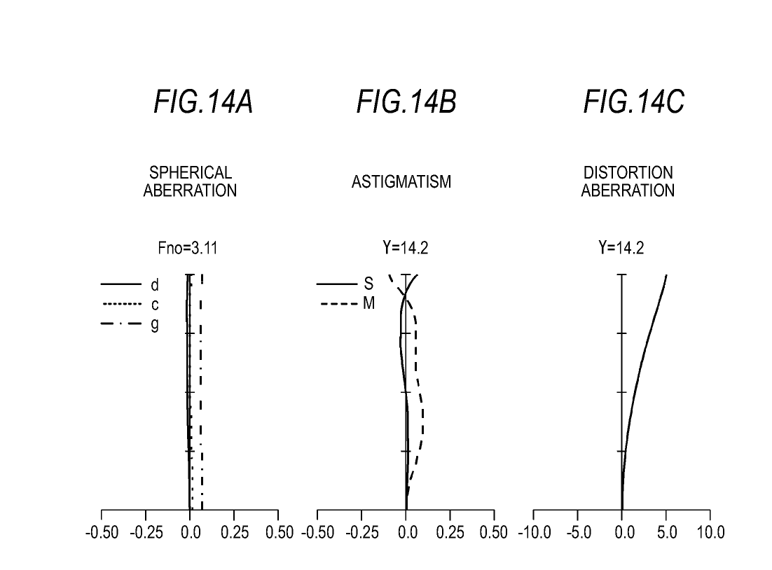

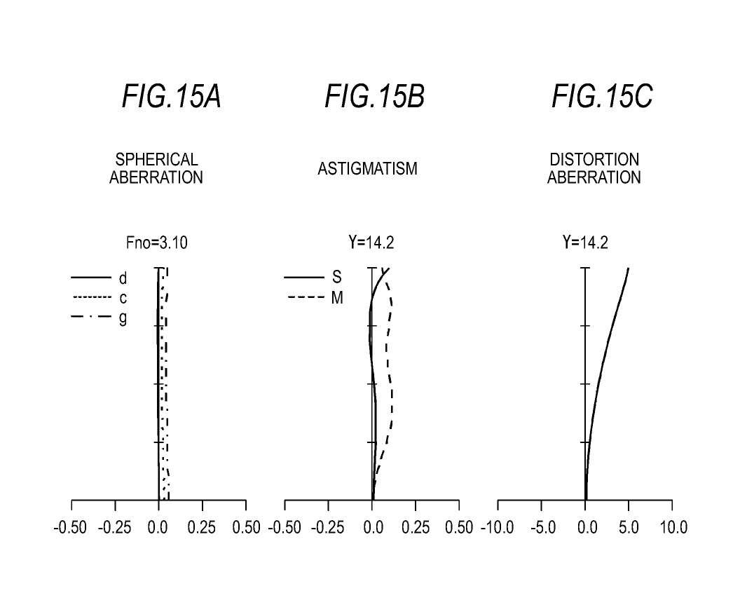

FIGS. 14A to 15C are diagrams illustrating the aberrations of the imaging lens according to the fifth embodiment. FIGS. 14A to 14C are diagrams illustrating the aberrations of the imaging lens according to the fifth embodiment at infinite focusing. FIGS. 15A to 15C are diagrams illustrating the aberrations of the imaging lens according to the fifth embodiment at short-distance focusing. The diagrams denoted by being posted by A, B, and C are diagrams illustrating a spherical aberration, astigmatism, and a distortion aberration. In addition, the types of lines shown in the diagrams illustrating the aberrations are similar to those described in the first embodiment.

s[Conclusion of Conditional Equations]

Table 16 represents the values in Numerical value Examples 1 to 5 according to the first to fifth embodiments. As is apparent from these values, Conditional Equations (1) to (6) are satisfied. In addition, as shown in the diagrams illustrating the aberrations, it can be understood that various types of aberrations are corrected with a balance at infinite focusing and short-distance focusing.

TABLE 16

| | Example 1 | Example 2 | Example 3 | Example 4 | Example 5 |
|---|---|---|---|---|---|
| Conditional | 0.191 | 0.443 | 0.474 | 0.489 | 0.440 |
| Equation (1) | | | | | |
| Conditional | 1.262 | 1.602 | 1.618 | 1.648 | 1.702 |
| Equation (2) | | | | | |
| Conditional | 1.581 | 1.541 | 1.541 | 1.541 | 1.541 |
| Equation (3) | | | | | |
| Conditional | 1.697 | 1.697 | 1.697 | 1.697 | 1.697 |
| Equation (4) | | | | | |
| Conditional | 1.694 | 1.589 | 1.589 | 1.589 | 1.589 |
| Equation (5) | | | | | |
| Conditional | −0.606 | −0.515 | −0.576 | −0.723 | −0.901 |
| Equation (6) | | | | | |

### 6. Application Example

### [Configuration of Imaging Apparatus]

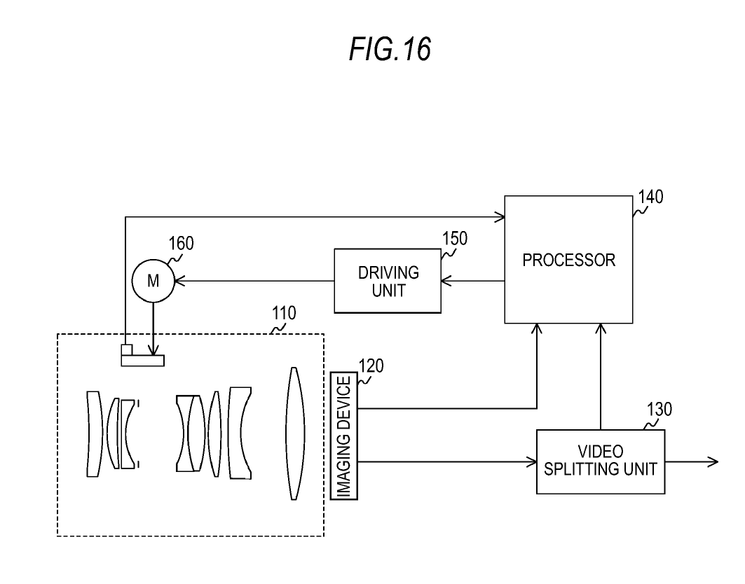

FIG. 16 is a diagram illustrating an example in which the imaging lens according to any one of the first to fifth embodiments is applied to an imaging apparatus 100. The imaging apparatus 100 includes: an imaging lens 110; an imaging device 120; a video splitting unit 130; a processor 140; a driving unit 150, and a motor 160.

The imaging lens 110 is the imaging lens according to any one of the first to fifth embodiments of the present disclosure.

The imaging device 120 converts an optical image formed by the imaging lens 110 into an electrical signal. As the imaging device 120, for example, a photoelectric conversion device such as a CCD (Charge Coupled Device) or a CMOS (Complementary Metal-Oxide Semiconductor) may be used.

The video splitting unit 130 generates a focus control signal based on the electrical signal supplied from the imaging device 120, transmits the focus control signal to the processor 140, and transmits a video signal, which corresponds to a video portion, of the electrical signal to a video processing circuit of a later stage (not illustrated in the figure). The video processing circuit is configured such that the video signal is converted into a signal format appropriate for a later process (not illustrated in the figure) and is provided for a video displaying process for a display unit, a recording process using a predetermined recording medium, a data transmitting process performed through a predetermined communication interface, or the like.

The processor 140 is supplied with an operation signal from the outside through a focusing operation or the like and performs various processes in accordance with the operation signal. In case where a focusing operation signal is supplied, for example, through a focusing button, the processor 140 operates the motor 160 through the driving unit 150 so as to form an in-focus state according to the instruction. Accordingly, the processor 140 of the imaging apparatus 100 moves the second lens group GR2 of the imaging lens 110 along the optical axis in accordance with the focusing operation signal. In addition, the processor 140 of the imaging apparatus 100 is configured to perform feedback of the position information of the second lens group GR2 at that time, and the position information can be referred to when the second lens group GR2 is moved through the motor 160 next time.

In this imaging apparatus 100, for simplification of the description, although only one system is illustrated as a driving system, a zoom system, a focus system, a photographing mode switching system, and the like may be individually included therein. In addition, in a case where a hand-shaking correcting function is included, an anti-vibration driving system used for driving a fluctuation correcting lens may be included. Furthermore, some of the above-described driving systems may be commonly configured.

Although an example is illustrated in the above-described embodiments in which the imaging apparatus 100 is assumed to be a digital still camera, the imaging apparatus 100 is not limited to the digital still camera. For example, the imaging apparatus 100 may be broadly applied to various electronic apparatuses such as an interchangeable lens camera, a digital video camera, a cellular phone in which a digital video camera or the like is built, or a PDA (Personal Digital Assistant).

As above, according to the embodiment of the present disclosure, by configuring the second lens group GR2 to be light-weighted, the second lens group GR2 as a focusing lens group can be moved at high speed by a small-size actuator.

In addition, since the above-described embodiment illustrates an example for realizing the technique disclosed here, each item described in the embodiment and an item specifying the present disclosure in the appended claims have correspondence relationship. Similarly, the item specifying the present disclosure in the appended claims and an item to which the same name is assigned in the embodiment of the present disclosure have the following correspondence relationship. However, the present disclosure is not limited to the embodiments of the present disclosure and may be realized by applying various modifications to the embodiments in the scope not departing from the concept thereof.

Furthermore, embodiments according to the present disclosure may have the following configurations.

(1) An imaging lens including: a first lens group; a diaphragm; a second lens group having positive refractive power; and a third lens group having negative refractive power, which are arranged in order from an object side, wherein the first lens group is configured by at least one positive lens and one negative lens, wherein the second lens group is configured by a negative lens, a positive lens, and a positive lens in order from the object side, and wherein, when focusing is performed, the second lens group is moved in a direction of an optical axis.

(2) The imaging lens described in (1), wherein the following Conditional Equations (1) and (2) are satisfied.

0.1<β2<0.8 (1)

1.1<β3<3.0 (2)

Here, β2 is the lateral magnification of the second lens group, and β3 is the lateral magnification of the third lens group.

(3) The imaging lens described in (1) or (2), wherein the following Conditional Equations (3), (4), and (5) are satisfied.

Nd21<1.7 (3)

Nd22<1.75 (4)

Nd23<1.75 (5)

Here, Nd21 is a refractive index of the medium of a lens, which is closest to the object side, of the second lens group for the d line (wavelength 587.6 nm), Nd22 is a refractive index of the medium of a lens, which is a lens located second from the object side, of the second lens group for the d line (wavelength 587.6 nm), and Nd23 is a refractive index of the medium of a lens, which is located third from the object side, of the second lens group for the d line (wavelength 587.6 nm).

(4) The imaging lens described in anyone of (1) to (3), wherein the following Conditional Equation (6) is satisfied.

−1.5<f21/f2<−0.3 (6)

Here, f21 is the focal length of a lens of the second lens group which is located closest to the object side, and f2 is the focal length of the second lens group.

(5) The imaging lens described in any one of (1) to (4), wherein the first lens group includes a cemented lens formed by bonding a positive lens and a negative lens in order from the object side.

(6) The imaging lens described in any one of (1) to (5), wherein the first lens group is configured by a positive lens, a positive lens, and a negative lens in order from the object side.

(7) The imaging lens described in any one of (1) to (5), wherein the third lens group is configured by a negative lens and a positive lens in order from the object side.

(8) An imaging apparatus including: an imaging lens is configured by a first lens group, a diaphragm, a second lens group having positive refractive power, and a third lens group having negative refractive power, in order from an object side and an imaging device that converts an optical image formed by the imaging lens into an electrical signal, wherein the first lens group is configured by at least one positive lens and one negative lens, wherein the second lens group is configured by a negative lens, a positive lens, and a positive lens in order from the object side, and wherein, when focusing is performed, the second lens group is moved in a direction of an optical axis.

The present disclosure contains subject matter related to that disclosed in Japanese Priority Patent Application JP 2011-031662 filed in the Japan Patent Office on Feb. 17, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging lens comprising:
a first lens group;
a diaphragm;
a second lens group having positive refractive power; and
a third lens group having negative refractive power, which are arranged in order from an object side,
wherein the first lens group is configured by at least one positive lens and one negative lens,
wherein the second lens group is configured by a negative lens, a positive lens, and a positive lens in order from the object side, and
wherein, when focusing is performed, the second lens group is moved in a direction of an optical axis.

2. The imaging lens according to claim 1, wherein the following Conditional Equations (1) and (2) are satisfied, wherein β2 is the lateral magnification of the second lens group, and β3 is the lateral magnification of the third lens group,
0.1<β2<0.8 (1)
1.1<β3<3.0 (2).

3. The imaging lens according to claim 1, wherein the following Conditional Equations (3), (4), and (5) are satisfied, wherein Nd21 is a refractive index of the medium of a lens, which is closest to the object side, of the second lens group for the d line (wavelength 587.6 nm), Nd22 is a refractive index of the medium of a lens, which is a lens located second from the object side, of the second lens group for the d line (wavelength 587.6 nm), and Nd23 is a refractive index of the medium of a lens, which is located third from the object side, of the second lens group for the d line (wavelength 587.6 nm),
Nd21<1.7 (3)
Nd22<1.75 (4)
Nd23<1.75 (5).

4. The imaging lens according to claim 1, wherein the following Conditional Equation (6) is satisfied, wherein f21 is the focal length of a lens of the second lens group which is located closest to the object side, and f2 is the focal length of the second lens group,
−1.5<f21/f2<−0.3 (6).

5. The imaging lens according to claim 1, wherein the first lens group includes a cemented lens formed by bonding a positive lens and a negative lens in order from the object side.

6. The imaging lens according to claim 1, wherein the first lens group is configured by a positive lens, a positive lens, and a negative lens in order from the object side.

7. The imaging lens according to claim 1, wherein the third lens group is configured by a negative lens and a positive lens in order from the object side.

8. An imaging apparatus comprising:
an imaging lens is configured by a first lens group, a diaphragm, a second lens group having positive refractive power, and a third lens group having negative refractive power, in order from an object side; and
an imaging device that converts an optical image formed by the imaging lens into an electrical signal,
wherein the first lens group is configured by at least one positive lens and one negative lens,
wherein the second lens group is configured by a negative lens, a positive lens, and a positive lens in order from the object side, and
wherein, when focusing is performed, the second lens group is moved in a direction of an optical axis.
